(19) United States
(12) Patent Application Publication
(10) Pub. No.: US 2014/0170551 A1
(43) Pub. Date: Jun. 19, 2014

(54) Tunable Gloss Toner

(71) Applicant: XEROX CORPORATION, Norwalk, CT (US)

(72) Inventors: Ke Zhou, Oakville (CA); Kimberly D. Nosella, Mississsauga (CA); Jordan H. Wosnick, Toronto (CA); Karen A. Moffat, Brantford (CA); Richard PN Veregin, Mississauga (CA); Santiago Faucher, Oakville (CA)

(73) Assignee: XEROX CORPORATION, Norwalk, CT (US)

(21) Appl. No.: 13/716,321

(22) Filed: Dec. 17, 2012

(51) Int. Cl. G03G 9/00; G03G 9/08

(52) U.S. Cl. CPC G03G 9/00; G03G 9/0802
USPC 430/108.21; 430/137.1; 430/108.2

(57) ABSTRACT

The disclosure describes an emulsion aggregation toner process wherein aspartic acid derivatives are employed as chelating agents. Also disclosed is a process for preparing toner using aspartic acid derivatives to freeze/stop toner particle growth where coalescence occurs following acidification of the reaction mixture.

### FIELD

Toners using biodegradable chelating agents during emulsion aggregation (EA) toner preparation; methods for making such toners; developers comprising said toners; devices comprising said toners and developers; imaging device components comprising said toners and developers; imaging devices comprising said developers; and so on, are described.

### BACKGROUND

In some current EA polyester toner designs, an aluminum salt is added as an aggregating agent during or after particle aggregation. Once the desired particle size is achieved, often, a chelator, such as, ethylenediaminetetraacetic acid (EDTA) is introduced to remove extra aluminum to prevent continued toner growth and to achieve higher image gloss.

Chelators, such as, EDTA and metal complexes thereof, may have a negative environmental impact. Hence, replacement of such potentially detrimental compounds is desirable.

### SUMMARY

The instant disclosure describes biodegradable aspartic acid derivatives as sequestering agents for EA toner preparation to remove excessive metal ion, such as, aluminum ion, in toner particles. In embodiments, aspartic acid derivatives include compounds comprising an a amino acid comprising a carboxylic acid group as the R group thereof, for instance, ethylenedisuccinic acid (EDDS), iminodisuccinic acid (ISA), N-bis[2-(1,2-dicarboxyethoxy)ethyl]aspartic acid (BCA6) and 3-hydroxy-2,2′-iminodisuccinic acid (HIDS).

In embodiments, following use of the biodegradable aspartic acid derivative for aggregation, toner coalescence is allowed to occur following acidification of the medium.

### DETAILED DESCRIPTION

Unless otherwise indicated, all numbers expressing quantities and conditions, and so forth used in the specification and claims are to be understood as being modified in all instances by the term, “about.” “About,” is meant to indicate a variation of no more than 20% from the stated value. Also used herein is the term, “equivalent,” “similar,” “essentially,” “substantially,” “approximating,” “matching” or grammatic variations thereof, each of which has a generally acceptable definition or at the least, is understood to have the same meaning as, “about.”

As used herein, “biodegradable,” generally relates to susceptibility of a compound or material to alteration by microbial action or to inherent lability which limits environmental persistence. Bio-based compounds are generally biodegradable. Environmental persistence may be measured as the time necessary for a certain degree of degradation or change over a period of a day, week, month or a minimal number of years, such as, about two years, about three years and so on.

As used herein, “pH adjuster” means an acid or base or buffer which may be used to change the pH of a composition (e.g., slurry, resin, aggregate, toner and the like). Such adjusters may include, but are not limited to, sodium hydroxide (NaOH), nitric acid, hydrochloric acid, a buffer, such as, sodium acetate/acetic acid and the like.

As used herein, a, “bio-based,” molecule is one which originates from a biological source, such as, a plant, an animal or a microbe, although the molecule may be made in vitro. Such molecules generally are biodegradable. A bio-based molecule is distinct from a, “chemical,” molecule which is one which is artificially synthesized and does not originate in a living organism. A chemical may be biologically compatible, that is, can be ingested or placed in a biologic or living entity without substantial adverse impact and may be biodegradable. However, degradation of that chemical in vivo may be slow, nonexistent or the chemical is converted to another chemical species that can have any of a variety of properties, including being biodegradable.

### Aggregating Factor/Flocculant

An aggregating factor comprises a metal ion and may be an inorganic cationic coagulant, such as, for example, polyaluminum chloride (PAC), polyaluminum sulfosilicate (PASS), aluminum sulfate, zinc sulfate, magnesium sulfate, chlorides of magnesium, calcium, zinc, beryllium, aluminum, sodium, other metal halides including monovalent and divalent halides.

The aggregating factor may be present in an emulsion in an amount of from, for example, from about 0 to about 10 wt %, from about 0.05 to about 5 wt % based on the total solids in the toner.

The aggregating factor may also contain minor amounts of other components, for example, nitric acid.

### Sequestering Agent

In embodiments, a bio-based sequestering agent is introduced during or after aggregation is complete. The bio-based sequestering agent comprises, for example, an organic acid or acid salt, such as, an α-amino acid.

Suitable organic acids include, for example carboxylic acids, dicarboxylic acids and the like, that can carry any number of backbone carbon residues, such as, for example, 4 or more carbons, 5 or more carbons, 6 or more carbons, and more. Suitable such carboxylic acids include amino acids, for example, aspartic acid and derivatives thereof which comprise an amino group and at least two carboxylic acid groups. Examples include, ethylenedisuccinic acid (EDDS), iminodisuccinic acid (ISA), N-bis[2-(1,2-dicarboxyethoxy)ethyl]aspartic acid (BCA6) and 3-hydroxy-2,2′-iminodisuccinic acid (HIDS). A derivative of aspartic acid is a compound that has at least one aspartic acid as a reagent or has a portion of which has a structure similar to or identical to that of aspartic acid, similar being containing at least an amino group and two carboxylic acid groups, with one of the carboxylic groups essentially represented by an aceto group, that is, a functional group derived from acetic acid.

The sequestering agent is added to an emulsion in amounts from at least about 0.5 parts per hundred (pph) based on the solids weight of the dry toner, at least about 1 pph, at least about 2 pph, at least 3 pph or more.

### I. Toner Particles

Toner particles of interest can comprise a polyacrylate, a polystyrene, a polyester resin and so on, as known in the art. Thus, a resin-forming monomer can be reacted with suitable other reactants to form a polymer resin.

Examples of suitable resins or polymers which may be utilized in forming a toner include, but are not limited to, poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly(methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene); poly(styrene-propyl acrylate), poly(styrene-butyl acrylate), poly(styrene-butadiene-acrylic acid), poly(styrene-butadiene-methacrylic acid), poly(styrene-butadiene-acrylonitrile-acrylic acid), poly(styrene-butyl acrylate-acrylic acid), poly(styrene-butyl acrylate-methacrylic acid), poly(styrene-butyl acrylate-acrylonitrile), poly(styrene-butyl acrylate-acrylonitrile-acrylic acid), and combinations thereof.

A toner composition can comprise more than one form or sort of polymer, such as, two or more different polymers, such as, two or more different polyester polymers composed of different monomers. The polymer can be an alternating copolymer, a block copolymer, a graft copolymer, a branched copolymer, a crosslinked copolymer and so on.

The toner particle can include other optional reagents, such as, a surfactant, a wax, a shell and so on. Such a toner particle can be from about 3 to about 7 μm in size, from about 3.5 to about 6.5 μm in size, from about 4 to about 6 μm in size. The toner composition optionally can comprise inert particles, which can serve as toner particle carriers, which can comprise the resin taught herein. The inert particles can be modified, for example, to serve a particular function. Hence, the surface thereof can be derivatized or the particles can be manufactured for a desired purpose, for example, to carry a charge or to possess a magnetic field.

The discussion below is directed to polyester resins, however, the features of the method of interest and the resulting product can be obtained using other resins used to make toner.

A. Components

1. Resin

Toner particles of the instant disclosure include a resin-forming monomer suitable for use in forming a particulate containing or carrying one or more colorants of a toner for use in certain imaging devices. The polyester-forming monomer is one that is inducible to form a resin, that is, which reacts, sets or solidifies to form a solid. Such a resin, a plastic, an elastomer and so on, whether naturally occurring or synthetic, is one that can be used in an imaging device. Generally, any suitable monomer or monomers are induced to polymerize to form a polyester resin or a copolymer. Any polyfunctional monomer may be used depending on the particular polyester polymer desired in a toner particle. Hence, bifunctional reagents, trifunctional reagents and so on can be used. One or more reagents that comprise at least three functional groups can be incorporated into a polymer or into a branch to enable branching, further branching and/or crosslinking. Examples of such polyfunctional monomers include 1,2,4-benzene-tricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxyl-2-methyl-2-methylene-carboxylpropane, tetra(methylene-carboxyl)methane and 1,2,7,8-octanetetracarboxylic acid.

One, two or more polymers may be used in forming a toner or toner particle. In embodiments where two or more polymers are used, the polymers may be in any suitable ratio (e.g., weight ratio) such as, for instance, with two different polymers, from about 1% (first polymer)/99% (second polymer) to about 99% (first polymer)/1% (second polymer), from about 10% (first polymer)/90% (second polymer) to about 90% (first polymer)/10% (second polymer) and so on, as a design choice. For example, a toner can comprise two forms of amorphous polyester resins and a crystalline resin in relative amounts as a design choice.

The polymer may be present in an amount of from about 65 to about 95% by weight, from about 75 to about 85% by weight of toner particles on a solids basis.

a. Polyester Resins

Suitable polyester resins include, for example, those which are sulfonated, non-sulfonated, crystalline, amorphous, combinations thereof and the like. The polyester resins may be linear, branched, crosslinked, combinations thereof and the like. Polyester resins may include those described, for example, in U.S. Pat. Nos. 6,593,049; 6,830,860; 7,754,406; 7,781,138; 7,749,672; and 6,756,176, the disclosure of each of which hereby is incorporated by reference in entirety.

When a mixture is used, such as, amorphous and crystalline polyester resins, the ratio of crystalline polyester resin to amorphous polyester resin can be in the range from about 1:99 to about 50:50; from about 5:95 to about 40:60; from about 5:95 to about 35:65.

A polyester resin may be obtained synthetically, for example, in an esterification reaction involving a reagent comprising a carboxylic acid group and another reagent comprising an alcohol. In embodiments, the alcohol reagent comprises two or more hydroxyl groups, three or more hydroxyl groups. In embodiments, the acid comprises two or more carboxylic acid groups, three or more carboxylic acid groups. Reagents comprising three or more functional groups enable, promote or enable and promote polymer branching and crosslinking. In embodiments, a polymer backbone or a polymer branch comprises at least one monomer unit comprising at least one pendant group or side group, that is, the monomer reactant from which the unit was obtained comprises at least three functional groups.

Examples of polyacids or polyesters that can be used for preparing an amorphous polyester resin include terephthalic acid, phthalic acid, isophthalic acid, fumaric acid, trimellitic acid, diethyl fumarate, dimethyl itaconate, cis-1,4-diacetoxy-2-butene, dimethyl fumarate, diethyl maleate, maleic acid, succinic acid, itaconic acid, succinic acid, cyclohexanoic acid, succinic anhydride, dodecylsuccinic acid, dodecylsuccinic anhydride, glutaric acid, glutaric anhydride, adipic acid, pimelic acid, suberic acid, azelaic acid, dodecanedioic acid, dimethyl naphthalenedicarboxylate, dimethylsuccinate, naphthalene dicarboxylic acid, dimer diacid, dimethylfumarate, dimethylmaleate, dimethylglutarate, dimethyladipate, dimethyl dodecylsuccinate, and combinations thereof. The polyacid or polyester reagent may be present in an amount from about 40 to about 60 mole % of the resin, from about 42 to about 52 mole % of the resin, from about 45 to about 50 mole % of the resin, and optionally a second polyacid can be used in an amount from about 0.1 to about 10 mole % of the resin.

Examples of polyols which may be used in generating an amorphous polyester resin include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, 1,4-cyclohexanedimethanol, 1,3-cyclohexanedimethanol, xylenedimethanol, cyclohexanediol, diethylene glycol, bis(2-hydroxyethyl)oxide, dipropylene glycol, dibutylene glycol, and combinations thereof. The amount of polyol can vary, and may be present, for example, in an amount from about 40 to about 60 mole % of the resin, from about 42 to about 55 mole % of the resin, from about 45 to about 53 mole % of the resin, and a second polyol, can be used in an amount from about 0.1 to about 10 mole %, from about 1 to about 4 mole % of the resin.

In embodiments, an unsaturated amorphous polyester resin may be used as a latex resin. Examples of such resins include those disclosed in U.S. Pat. No. 6,063,827, the disclosure of which is hereby incorporated by reference in entirety.

In embodiments, when two amorphous polyester resins are utilized, one of the amorphous polyester resins may be of high molecular weight (HMW) and the second amorphous polyester resin may be of low molecular weight (LMW). As used herein, an HMW amorphous resin may have, for example, a weight average molecular weight (M_{w}) greater than about 55,000, for example, from about 55,000 to about 150,000, from about 50,000 to about 100,000, from about 60,000 to about 95,000, from about 70,000 to about 85,000, as determined by gel permeation chromatography (GPC), using polystyrene standards.

An HMW amorphous polyester resin may have an acid value of from about 8 to about 20 mg KOH/grams, from about 9 to about 16 mg, from about 11 to about 15 mg KOH/grams. The HMW amorphous polyester resin, which is available from a number of commercial sources, can possess various melting points of, for example, from about 30° C. to about 140° C., from about 75° C. to about 130° C., from about 100° C. to about 125° C., from about 115° C. to about 121° C.

An LMW amorphous polyester resin has, for example, an M_{w}, of 50,000 or less, for example, from about 2,000 to about 50,000, from about 3,000 to about 40,000, from about 10,000 to about 30,000, from about 15,000 to about 25,000, as determined by GPC using polystyrene standards. The LMW amorphous polyester resins, available from commercial sources, may have an acid value of from about 8 to about 20 mg KOH/grams, from about 9 to about 16 mg KOH/grams, from about 10 to about 14 mg KOH/grams. The LMW amorphous resins can possess an onset T_{g} of, for example, from about 40° C. to about 80° C., from about 50° C. to about 70° C., from about 58° C. to about 62° C., as measured by, for example, differential scanning calorimetry (DSC).

For forming a crystalline polyester resin, suitable polyols include aliphatic polyols with from about 2 to about 36 carbon atoms, such as 1,2-ethanediol, 1,3-propanediol, 1,4-butanediol, 1,5-pentanediol, 2,2-dimethylpropane-1,3-diol, 1,6-hexanediol, 1,7-heptanediol, 1,8-octanediol, 1,9-nonanediol, 1,10-decanediol, 1,12-dodecanediol and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixture thereof and the like, including structural isomers thereof. The aliphatic polyol may be, for example, selected in an amount from about 40 to about 60 mole %, from about 42 to about 55 mole %, from about 45 to about 53 mole %, and a second polyol, can be used in an amount from about 0.1 to about 10 mole %, from about 1 to about 4 mole % of the resin.

Examples of polyacid or polyester reagents for preparing a crystalline resin include oxalic acid, succinic acid, glutaric acid, adipic acid, suberic acid, azelaic acid, sebacic acid, fumaric acid, dimethyl fumarate, dimethyl itaconate, cis, 1,4-diacetoxy-2-butene, diethyl fumarate, diethyl maleate, naphthalene-2,6-dicarboxylic acid, naphthalene-2,7-dicarboxylic acid, cyclohexane dicarboxylic acid (sometimes referred to herein as cyclohexanedioic acid), malonic acid and mesaconic acid, a polyester or anhydride thereof; and an alkali sulfo-organic polyacid, such as, 4-sulfophenyl-3,5-dicarbomethoxybenzene, 6-sulfo-2-naphthyl-3,5-dicarbomethoxybenzene, sulfo-p-hydroxybenzoic acid, N,N-bis(2-hydroxyethyl)-2-amino ethane sulfonate, or mixtures thereof. The polyacid may be selected in an amount of, for example, from about 40 to about 60 mole %, from about 42 to about 52 mole %, from about 45 to about 50 mole %, and optionally, a second polyacid can be selected in an amount from about 0.1 to about 10 mole % of the resin.

Specific crystalline resins include poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), copoly(2,2-dimethylpropane-1,3-diol-decanoate)-copoly(ethylene-adipate), and so on, wherein alkali is a metal like sodium, lithium or potassium. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), and poly(propylene-sebecamide). Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), and poly(butylene-succinimide).

Suitable crystalline resins which may be utilized, optionally in combination with an amorphous resin as described above, include those disclosed in U.S. Pub. No. 2006/0222991, the disclosure of which is hereby incorporated by reference in entirety.

In embodiments, a suitable crystalline resin may include a resin formed of ethylene glycol and a mixture of dodecanedioic acid and fumaric acid co-monomers.

The crystalline resin may be present, for example, in an amount from about 1 to about 85% by weight of the toner components, from about 2 to about 50% by weight of the toner components, from about 5 to about 35% by weight of the toner components. The crystalline resin can possess various melting points of, for example, from about 30° C. to about 120° C., from about 50° C. to about 90° C., from about 60° C. to about 80° C. The crystalline resin may have a number average molecular weight (Mₙ), as measured by gel permeation chromatography (GPC) of, for example, from about 1,000 to about 50,000, from about 2,000 to about 25,000, and an M_{w} of, for example, from about 2,000 to about 100,000, from about 3,000 to about 80,000, as determined by GPC using polystyrene standards. The molecular weight distribution (M_{w}/Mₙ) of the crystalline resin may be from about 2 to about 6, from about 3 to about 4.

b. Catalyst

Condensation catalysts may be used in the polyester reaction and include tetraalkyl titanates; dialkyltin oxides, such as, dibutyltin oxide; tetraalkyltins, such as, dibutyltin dilaurate; dibutyltin diacetate; dibutyltin oxide; dialkyltin oxide hydroxides, such as, butyltin oxide hydroxide; aluminum alkoxides, alkyl zinc, dialkyl zinc, zinc oxide, stannous oxide, stannous chloride, butylstannoic acid, or combinations thereof.

Such catalysts may be used in amounts of, for example, from about 0.01 mole % to about 5 mole % based on the amount of starting polyacid, polyol or polyester reagent in the reaction mixture.

Generally, as known in the art, the polyacid/polyester and polyols reagents, are mixed together, optionally with a catalyst, and incubated at an elevated temperature, such as, from about 180° C. or more, from about 190° C. or more, from about 200° C. or more, and so on, which can be conducted anaerobically, to enable esterification to occur until equilibrium, which generally yields water or an alcohol, such as, methanol, arising from forming the ester bonds in esterification reactions. The reaction can be conducted under vacuum to promote polymerization.

c. Branching Agents

Branching agents can be used, and include, for example, a multivalent polyacid such as 1,2,4-benzene-tricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxyl-2-methyl-2-methylene-carboxylpropane, tetra(methylene-carboxyl)methane, 1,2,7,8-octanetetracarboxylic acid, acid anhydrides thereof, lower alkyl esters thereof and so on. The branching agent can be used in an amount from about 0.01 to about 10 mole % of the resin, from about 0.05 to about 8 mole %, from about 0.1 to about 5 mole % of the resin.

It may be desirable to crosslink the polymer to form a gel latex, and presence of gel latex can reduce gloss. A suitable resin conducive to crosslinking is one with a reactive group, such as, a C═C bond or with pendant or side groups, such as, a carboxylic acid group. The resin can be crosslinked, for example, through free radical polymerization with an initiator. Suitable initiators include peroxides, such as, organic peroxides or azo compounds, for example diacyl peroxides, such as, decanoyl peroxide, lauroyl peroxide and benzoyl peroxide, ketone peroxides, such as, cyclohexanone peroxide and methyl ethyl ketone, alkyl peroxy esters, such as, t-butyl peroxy neodecanoate, 2,5-dimethyl 2,5-di(2-ethyl hexanoyl peroxy)hexane, t-amyl peroxy 2-ethyl hexanoate, t-butyl peroxy 2-ethyl hexanoate, t-butyl peroxy acetate, t-amyl peroxy acetate, t-butyl peroxy benzoate, t-amyl peroxy benzoate, alkyl peroxides, such as, dicumyl peroxide, 2,5-dimethyl 2,5-di(t-butyl peroxy)hexane, t-butyl cumyl peroxide, bis(t-butyl peroxy)diisopropyl benzene, di-t-butyl peroxide and 2,5-dimethyl 2,5-di(t-butyl peroxy)hexyne-3, alkyl hydroperoxides, such as, 2,5-dihydro peroxy 2,5-dimethyl hexane, cumene hydroperoxide, t-butyl hydroperoxide and t-amyl hydroperoxide, and alkyl peroxyketals, such as, n-butyl 4,4-di(t-butyl peroxy)valerate, 1,1-di(t-butyl peroxy) 3,3,5-trimethyl cyclohexane, 1,1-di(t-butyl peroxy)cyclohexane, 1,1-di(t-amyl peroxy)cyclohexane, 2,2-di(t-butyl peroxy)butane, ethyl 3,3-di(t-butyl peroxy)butyrate and ethyl 3,3-di(t-amyl peroxy)butyrate, azobis-isobutyronitrile, 2,2′-azobis(isobutyronitrile), 2,2′-azobis(2,4-dimethyl valeronitrile), 2,2′-azobis(methyl butyronitrile), 1,1′-azobis(cyano cyclohexane), 1,1-di(t-butyl peroxy)-3,3,5-trimethylcyclohexane, combinations thereof and the like. The amount of initiator used is proportional to the degree of crosslinking, and thus, the gel content of the polyester material. The amount of initiator used may range from, for example, about 0.01 to about 10 weight %, from about 0.1 to about 5 weight % of the polyester resin. In the crosslinking, it is desirable that substantially all of the initiator be consumed. The crosslinking may be carried out at high temperature, and thus the reaction may be very fast, for example, less than 10 minutes, such as, from about 20 seconds to about 2 minutes residence time.

Hence, disclosed herein is a polyester resin suitable for use in imaging which can comprise a mixture of the relevant reagents prior to polymerization, such as, a polyacid/polyester reagent and a polyol reagent. In embodiments, a polyester resin is produced and processed to form a polymer reagent, which can be dried and formed into flowable particles, such as, a pellet, a powder and the like. The polymer reagent then can be incorporated with, for example, other reagents suitable for making a toner particle, such as, a colorant and/or a wax, and processed in a known manner to produce toner particles.

Polyester resins suitable for use in an imaging device can be those which carry one or more properties, such as, a T_{g} (onset) of at least about 40° C., at least about 45° C., at least about 50° C., at least about 55° C.; a Tₛ of at least about 100° C., at least about 105° C., at least about 110° C., at least about 115° C.; an acid value (AV) of at least about 5, at least about 7, at least about 9, at least about 10; and an M_{W} of at least about 5000, at least about 15,000, at least about 20,000, at least about 100,000.

2. Colorants

Suitable colorants include those comprising carbon black, such as, REGAL 330® and Nipex 35; magnetites, such as, Mobay magnetites, MO8029™ and MO8060™; Columbian magnetites, MAPICO® BLACK; surface-treated magnetites; Pfizer magnetites, CB4799™, CB5300™, CB5600™ and MCX6369™; Bayer magnetites, BAYFERROX 8600 ™ and 8610™; Northern Pigments magnetites, NP604™ and NP608™; Magnox magnetites, TMB-100™ or TMB-104™; and the like.

Colored pigments, such as, cyan, magenta, yellow, red, orange, green, brown, blue or mixtures thereof can be used. The additional pigment or pigments can be used as water-based pigment dispersions.

Examples of pigments include SUNSPERSE 6000, FLEXIVERSE and AQUATONE, water-based pigment dispersions from SUN Chemicals; HELIOGEN BLUE L6900™, D6840™, D7080™, D7020™, PYLAM OIL BLUE™ PYLAM OIL YELLOW™ and PIGMENT BLUE I™ available from Paul Uhlich & Company, Inc.; PIGMENT VIOLET I™, PIGMENT RED 48™, LEMON CHROME YELLOW DCC 1O2™, TOLUIDINE RED™ and BON RED C™ available from Dominion Color Corporation, Ltd., Toronto, Ontario; NOVAPERM YELLOW FGL™ and HOSTAPERM PINK E™ from Hoechst; CINQUASIA MAGENTA™ available from E.I. DuPont de Nemours & Co. and the like.

Examples of magenta pigments include 2,9-dimethyl-substituted quinacridone, an anthraquinone dye identified in the Color Index as CI 60710, CI Dispersed Red 15, a diazo dye identified in the Color Index as CI 26050, CI Solvent Red 19 and the like.

Illustrative examples of cyan pigments include copper tetra(octadecylsulfonamido) phthalocyanine, a copper phthalocyanine pigment listed in the Color Index as CI 74160, CI Pigment Blue, Pigment Blue 15:3, Pigment Blue 15:4, an Anthrazine Blue identified in the Color Index as CI 69810, Special Blue X-2137 and the like.

Illustrative examples of yellow pigments are diarylide yellow 3,3-dichlorobenzidene acetoacetanilide, a monoazo pigment identified in the Color Index as CI 12700, CI Solvent Yellow 16, a nitrophenyl amine sulfonamide identified in the Color Index as Foron Yellow SE/GLN, CI Disperse Yellow 3, 2,5-dimethoxy-4-sulfonanilide phenylazo-4′-chloro-2,5-dimethoxy acetoacetanilide and Permanent Yellow FGL.

Other known colorants can be used, such as, Levanyl Black A-SF (Miles, Bayer) and Sunsperse Carbon Black LHD 9303 (Sun Chemicals), and colored dyes, such as, Neopen Blue (BASF), Sudan Blue OS (BASF), PV Fast Blue B2G 01 (American Hoechst), Sunsperse Blue BHD 6000 (Sun Chemicals), Irgalite Blue BCA (CibaGeigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), SUCD-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing and the like. Other pigments that can be used, and which are commercially available include various pigments in the color classes, Pigment Yellow 74, Pigment Yellow 14, Pigment Yellow 83, Pigment Orange 34, Pigment Red 238, Pigment Red 122, Pigment Red 48:1, Pigment Red 269, Pigment Red 53:1, Pigment Red 57:1, Pigment Red 83:1, Pigment Violet 23, Pigment Green 7 and so on, and combinations thereof.

The colorant, for example, carbon black, cyan, magenta and/or yellow colorant, may be incorporated in an amount sufficient to impart the desired color to the toner. In general, pigment or dye, may be employed in an amount ranging from about 2% to about 35% by weight of the toner particles on a solids basis, from about 5% to about 25% by weight, from about 5% to about 15% by weight.

In embodiments, more than one colorant may be present in a toner particle. For example, two colorants may be present in a toner particle, such as, a first colorant of, for example, pigment blue, may be present in an amount ranging from about 2% to about 10% by weight of the toner particle on a solids basis, from about 3% to about 8% by weight, from about 5% to about 10% by weight; with a second colorant of, for example, pigment yellow, that may be present in an amount ranging from about 5% to about 20% by weight of the toner particle on a solids basis, from about 6% to about 15% by weight, from about 10% to about 20% by weight and so on.

3. Optional Components

a. Surfactants

In embodiments, toner compositions may be in dispersions including surfactants. Emulsion aggregation methods where the polymer and other components of the toner are in combination can employ one or more surfactants to form an emulsion.

One, two or more surfactants may be used. The surfactants may be selected from ionic surfactants and nonionic surfactants, or combinations thereof. Anionic surfactants and cationic surfactants are encompassed by the term, “ionic surfactants.”

In embodiments, the surfactant or the total amount of surfactants may be used in an amount of from about 0.01% to about 5% by weight of the toner-forming composition, for example, from about 0.75% to about 4% by weight of the toner-forming composition, in embodiments, from about 1% to about 3% by weight of the toner-forming composition.

Examples of nonionic surfactants include, for example, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether and dialkylphenoxy poly(ethyleneoxy)ethanol, for example, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. Other examples of suitable nonionic surfactants include a block copolymer of polyethylene oxide and polypropylene oxide, including those commercially available as SYNPERONIC® PR/F, in embodiments, SYNPERONIC® PR/F 108; and a DOWFAX, available from The Dow Chemical Corp.

Anionic surfactants include sulfates and sulfonates, such as, sodium dodecylsulfate (SDS), sodium dodecylbenzene sulfonate, sodium dodecylnaphthalene sulfate and so on; dialkyl benzenealkyl sulfates; acids, such as, palmitic acid, and NEOGEN or NEOGEN SC obtained from Daiichi Kogyo Seiyaku, and so on, combinations thereof and the like. Other suitable anionic surfactants include, in embodiments, alkyldiphenyloxide disulfonates or TAYCA POWER BN2060 from Tayca Corporation (Japan), which is a branched sodium dodecyl benzene sulfonate. Combinations of those surfactants and any of the foregoing nonionic surfactants may be used in embodiments.

Examples of cationic surfactants include, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, trimethyl ammonium bromides, halide salts of quarternized polyoxyethylalkylamines, dodecylbenzyl triethyl ammonium chlorides, MIRAPOL® and ALKAQUAT® available from Alkaril Chemical Company, SANISOL® (benzalkonium chloride) available from Kao Chemicals and the like, and mixtures thereof, including, for example, a nonionic surfactant as known in the art or provided hereinabove.

b. Waxes

The toners of the instant disclosure, optionally, may contain a wax, which can be either a single type of wax or a mixture of two or more different types of waxes (hereinafter identified as, “a wax”). A wax can be added to a toner formulation or to a developer formulation, for example, to improve particular toner properties, such as, toner particle shape, charging, fusing characteristics, gloss, stripping, offset properties and the like. Alternatively, a combination of waxes can be added to provide multiple properties to a toner or a developer composition. A wax may be included as, for example, a fuser roll release agent.

The wax may be combined with the resin-forming composition for forming toner particles. When included, the wax may be present in an amount of, for example, from about 1 wt % to about 25 wt % of the toner particles, from about 5 wt % to about 20 wt % of the toner particles.

Waxes that may be selected include waxes having, for example, a weight average molecular weight of from about 500 to about 20,000, from about 1,000 to about 10,000. Waxes that may be used include, for example, polyolefins, such as, polyethylene, polypropylene and polybutene waxes, such as, those that are commercially available, for example, POLYWAX™ polyethylene waxes from Baker Petrolite, wax emulsions available from Michaelman, Inc. or Daniels Products Co., EPOLENE N15™ which is commercially available from Eastman Chemical Products, Inc., VISCOL 550-P™, a low weight average molecular weight polypropylene available from Sanyo Kasei K.K. and R3690A, a polymethylene wax from IGI; plant-based waxes, such as carnauba wax, rice wax, candelilla wax, sumac wax and jojoba oil; animal-based waxes, such as beeswax; paraffin wax, microcrystalline wax and Fischer-Tropsch waxes; ester waxes obtained from higher fatty acids and higher alcohols, such as stearyl stearate and behenyl behenate; ester waxes obtained from higher fatty acids and monovalent or multivalent lower alcohols, such as butyl stearate, propyl oleate, glyceride monostearate, glyceride distearate and pentaerythritol tetrabehenate; ester waxes obtained from higher fatty acids and multivalent alcohol multimers, such as diethyleneglycol monostearate, dipropyleneglycol distearate, diglyceryl distearate and triglyceryl tetrastearate; sorbitan higher fatty acid ester waxes, such as sorbitan monostearate; cholesterol higher fatty acid ester waxes, such as, cholesteryl stearate, and so on.

Examples of functionalized waxes that may be used include, for example, amines and amides, for example, AQUA SUPERSLIP 6550™ and SUPERSLIP 6530™ available from Micro Powder Inc.; fluorinated waxes, for example, POLYFLUO 190™, POLYFLUO 200™, POLYSILK 19™ and POLYSILK 14™ available from Micro Powder Inc.; mixed fluorinated amide waxes, for example, MICROSPERSION 19™ also available from Micro Powder Inc.; imides, esters, quaternary amines, carboxylic acids, acrylic polymer emulsions, for example, JONCRYL 74™, 89™, 130™, 537™ and 538™ available from SC Johnson Wax; and chlorinated polypropylenes and polyethylenes available from Allied Chemical, Petrolite Corp. and SC Johnson. Mixtures and combinations of the foregoing waxes also may be used in embodiments.

For low melt applications, a wax can be selected that has a lower melting point, such as, less than about 125° C., less than about 120° C., less than about 115° C., less than about 110° C. or lower.

B. Toner Particle Preparation

1. Method

a. Particle Formation

The toner particles may be prepared by any method within the purview of one skilled in the art, for example, any of the emulsion/aggregation (EA) methods can be used with the polyester resin. However, any suitable method of preparing toner particles may be used, including chemical processes, such as, suspension and encapsulation processes disclosed, for example, in U.S. Pat. Nos. 5,290,654 and 5,302,486, the disclosure of each of which hereby is incorporated by reference in entirety; by conventional granulation methods, such as, jet milling; pelletizing slabs of material; other mechanical processes; any process for producing nanoparticles or microparticles; and so on.

In embodiments relating to an emulsification/aggregation process, a resin can be dissolved in a solvent and can be mixed into an emulsion medium, for example water, such as, deionized water, and optionally a surfactant. Suitable surfactants include anionic, cationic and nonionic surfactants as taught herein.

Following emulsification, toner compositions may be prepared by aggregating a mixture of one or more resins, an optional wax and any other desired additives in an emulsion, optionally, with surfactants as described above, and then optionally coalescing the aggregate mixture. A mixture may be prepared by adding an optional colorant, which may be a mixture of two or more emulsions containing the requisite reagents. The pH of the resulting mixture may be adjusted with an acid, such as, for example, acetic acid, nitric acid or the like. In embodiments, the pH of the mixture may be adjusted to from about 2 to about 4.5.

Additionally, in embodiments, the mixture may be homogenized. If the mixture is homogenized, mixing can be at from about 600 to about 4,000 rpm. Homogenization may be by any suitable means, including, for example, an IKA ULTRA TURRAX T50 probe homogenizer.

b. Aggregation

Following preparation of the above mixture, often, it is desirable to form larger particles or aggregates, often sized in micrometers, of the smaller particles from the initial polymerization reaction, often sized in nanometers. An aggregating factor or flocculant may be added to the mixture. Suitable aggregating factors include, for example, aqueous solutions of a divalent cation, a multivalent cation or a compound comprising same.

The aggregating factor, as provided above, may be, for example, a polyaluminum halide, such as, polyaluminum chloride (PAC) or the corresponding bromide, fluoride or iodide; a polyaluminum silicate, such as, polyaluminum sulfosilicate (PASS); or a water soluble metal salt, including, aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate or combinations thereof.

In embodiments, the aggregating factor may be added to the mixture at a temperature that is below the glass transition temperature (T_{g}) of the resin or of a polymer.

The aggregating factor may be added to the mixture components to form a toner in an amount of, for example, from about 0.1 pph to about 5 pph, from about 0.2 pph to about 2 pph.

To control aggregation, the aggregating factor may be metered into the mixture over time. Thus, the factor may be added incrementally into the mixture over a period of from about 5 to about 240 min, from about 30 to about 200 min.

Addition of the aggregating factor may be done while the mixture is homogenized, which can be at from about 600 to about 4,000 rpm. Homogenization may be by any suitable means, including, for example, an IKA ULTRA TURRAX T50 probe homogenizer, and at a temperature that is below the T_{g} of the resin or polymer, in embodiments, from about 0° C. to about 60° C., from about 1° C. to about 50° C. The growth and shaping of the particles following addition of the aggregation factor may be accomplished under any suitable condition(s).

Addition of the aggregating factor also may be done while the mixture is stirred, from about 50 to about 1,000 rpm, from about 100 to about 500 rpm.

The pH of the emulsion can vary from about 3 to about 9, from about 4 to about 8, as a design choice.

The particles may be permitted to aggregate until a predetermined desired particle size is obtained. Particle size can be monitored during the growth process. For example, samples may be taken during the growth process and analyzed, for example, with a COULTER COUNTER, for average particle size. The aggregation thus may proceed by maintaining the mixture, for example, at elevated temperature, or slowly raising the temperature, for example, from about 40° C. to about 100° C., from about 50° C. to about 100° C., from about 65° C. to about 99° C., and holding the mixture at that temperature for from about 0.5 hours to about 6 hours, from about hour 1 to about 5 hours, while maintaining stirring, to provide the desired aggregated particles. Hence, the mixture is raised to a temperature that is about 100° C., about 99° C., about 98° C. Once the predetermined desired particle size is attained, the growth process is halted. A sequestering agent of interest can be added to the emulsion before or when the desired particle size is obtained.

Once the desired final size of the toner particles or aggregates is achieved, the pH of the mixture may be adjusted with base to a value of from about 4 to about 12, from about 4 to about 8, from about 6 to about 10. The adjustment of pH may be used to freeze, that is, to stop, toner particle growth. The base used to stop toner particle growth may be, for example, an alkali metal hydroxide, such as, for example, sodium hydroxide, potassium hydroxide, ammonium hydroxide, combinations thereof and the like. In embodiments, a sequestering agent may be added to assist adjusting the pH to the desired value.

The base may be added in amounts from about 2 to about 25% by weight of the mixture, from about 4 to about 10% by weight of the mixture. Following aggregation to the desired particle size, with the formation of an optional shell as described herein, the particles then may be coalesced to the desired final shape.

The characteristics of the toner particles may be determined by any suitable technique and apparatus. Volume average particle diameter and geometric standard deviation may be measured using an instrument, such as, a Beckman Coulter MULTISIZER 3, operated in accordance with the instructions of the manufacturer.

The growth and shaping may be conducted under conditions in which aggregation occurs separate from coalescence. For separate aggregation and coalescence stages, the aggregation process may be conducted under shearing conditions at an elevated temperature, for example, of from about 40° C. to about 65° C., from about 45° C. to about 65° C., which may be below the T_{g} of the resin or a polymer.

In embodiments, the aggregate particles may be of a size of less than about 5.5 μm, from about 4.0 μm to about 5.0 μm, from about 4.5 μm to about 5.0 μm.

c. Coalescence

Following aggregation to a desired particle size and application of any optional shell, the particles then may be coalesced to a desired final shape, such as, a circular shape, for example, to correct for irregularities in shape and size, the coalescence being achieved by, for example, heating the mixture to a temperature from about 45° C. to about 85° C., from about 55° C. to about 80° C., which may be at or above the T_{g} of the resins used to form the toner particles, and/or reducing the stirring, for example to from about 1000 rpm to about 100 rpm, from about 800 rpm to about 200 rpm. Coalescence may be conducted over a period from about 0.01 to about 9 hours, from about 0.1 to about 4 hours, see, for example, U.S. Pat. No. 7,736,831.

The pH of the mixtures is adjusted to from about 4 to about 8, from about 5 to about 7.5, from about 6 to about 7.25 using an acid or a buffer, as known and available in the art. Examples of an acid include hydrochloric acid, nitric acid, acetic acid, citric acid and so on. Examples of a buffer include a citric acid/sodium citrate buffer and so on.

After aggregation and/or coalescence, the mixture may be cooled to room temperature, such as, from about 20° C. to about 25° C. The cooling may be rapid or slow, as desired. A suitable cooling method may include introducing cold water to a jacket around the reactor or discharging toner into cold water. After cooling, the toner particles optionally may be washed with water and then dried. Drying may be by any suitable method, including, for example, freeze-drying.

Optionally, a coalescing agent can be used. Examples of suitable coalescence agents include, but are not limited to, benzoic acid alkyl esters, ester alcohols, glycol/ether-type solvents, long chain aliphatic alcohols, aromatic alcohols, mixtures thereof and the like. Examples of benzoic acid alkyl esters include those where the alkyl group, which can be straight or branched, substituted or unsubstituted, has from about 2 to about 30 carbon atoms, such as decyl or isodecyl benzoate, nonyl or isononyl benzoate, octyl or isooctyl benzoate, 2-ethylhexyl benzoate, tridecyl or isotridecyl benzoate, 3,7-dimethyloctyl benzoate, 3,5,5-trimethylhexyl benzoate, mixtures thereof and the like. Examples of such benzoic acid alkyl esters include VELTA® 262 (isodecyl benzoate) and VELTA® 368 (2-ethylhexyl benzoate) available from Velsicol Chemical Corp. Examples of ester alcohols include hydroxyalkyl esters of alkanoic acids, where the alkyl group, which can be straight or branched, substituted or unsubstituted, and can have from about 2 to about 30 carbon atoms, such as, 2,2,4-trimethylpentane-1,3-diol monoisobutyrate. An example of an ester alcohol is TEXANOL® (2,2,4-trimethylpentane-1,3-diol monoisobutyrate) available from Eastman Chemical Co. Examples of glycol/ether-type solvents include diethylene glycol monomethylether acetate, diethylene glycol monobutylether acetate, butyl carbitol acetate (BCA) and the like. Examples of long chain aliphatic alcohols include those where the alkyl group is from about 5 to about 20 carbon atoms, such as, ethylhexanol, octanol, dodecanol and the like. Examples of aromatic alcohols include benzyl alcohol and the like.

In embodiments, the coalescence agent (or coalescing agent or coalescence aid agent) evaporates during later stages of the emulsion/aggregation process, such as, during a second heating step, that is, generally above the T_{g} of the resin or a polymer. The final toner particles are thus, free of, or essentially or substantially free of any remaining coalescence agent. To the extent that any remaining coalescence agent may be present in a final toner particle, the amount of remaining coalescence agent is such that presence thereof does not affect any properties or the performance of the toner or developer.

The coalescence agent can be added prior to the coalescence or fusing step in any desired or suitable amount. For example, the coalescence agent can be added in an amount of from about 0.01 to about 10% by weight, based on the solids content in the reaction medium, from about 0.05, from about 0.1%, to about 0.5, to about 3.0% by weight, based on the solids content in the reaction medium. Of course, amounts outside those ranges can be used, as desired.

In embodiments, the coalescence agent can be added at any time between aggregation and coalescence, although in some embodiments it may be desirable to add the coalescence agent after aggregation is, “frozen,” or completed, for example, by adjustment of pH, for example, by addition, for example, of base.

Coalescence may proceed and be accomplished over a period of from about 0.1 to about 9 hours, from about 0.5 to about 4 hours.

d. Shells

In embodiments, an optional shell may be applied to the formed toner particles, aggregates or coalesced particles. Any polymer, including those described above as suitable for the core, may be used for the shell. The shell polymer may be applied to the particles or aggregates by any method within the purview of those skilled in the art.

In embodiments, an amorphous polyester resin may be used to form a shell over the particles or aggregates to form toner particles or aggregates having a core-shell configuration.

The shell polymer may be in an amount of from about 1% to about 80%, from about 5% to about 50% by weight of the toner particles or aggregates.

e. Optional Additives

In embodiments, the toner particles also may contain other optional additives.

i. Charge Additives

The toner may include any known charge additives in amounts of from about 0.1 to about 10 weight %, from about 0.5 to about 7 weight % of the toner. Examples of such charge additives include alkyl pyridinium halides, bisulfates, the charge control additives of U.S. Pat. Nos. 3,944,493; 4,007,293; 4,079,014; 4,394,430; and 4,560,635, the disclosure of each of which hereby is incorporated by reference in entirety, negative charge enhancing additives, such as, aluminum complexes, and the like.

Charge enhancing molecules can be used to impart either a positive or a negative charge on a toner particle. Examples include quaternary ammonium compounds, see, for example, U.S. Pat. No. 4,298,672, organic sulfate and sulfonate compounds, see for example, U.S. Pat. No. 4,338,390, cetyl pyridinium tetrafluoroborates, distearyl dimethyl ammonium methyl sulfate, aluminum salts and so on.

Such enhancing molecules can be present in an amount of from about 0.1 to about 10%, from about 1 to about 3% by weight.

ii. Surface Modifications

Surface additives can be added to the toner compositions of the present disclosure, for example, after washing or drying. Examples include one or more of a metal salt, a metal salt of a fatty acid, a colloidal silica, a metal oxide, such as, TiO₂ (for example, for improved RH stability, tribo control and improved development and transfer stability), an aluminum oxide, a cerium oxide, a strontium titanate, SiO₂, mixtures thereof and the like. Examples of such additives include those disclosed in U.S. Pat. Nos. 3,590,000; 3,720,617; 3,655,374; and 3,983,045, the disclosure of each of which hereby is incorporated by reference in entirety.

Surface additives may be used in an amount of from about 0.1 to about 10 wt %, from about 0.5 to about 7 wt % of the toner.

Surface additives include lubricants, such as, a metal salt of a fatty acid (e.g., calcium stearate) or long chain alcohols, such as, UNILIN 700 available from Baker Petrolite and AEROSIL R972® available from Degussa. The coated silicas of U.S. Pat. Nos. 6,190,815 and 6,004,714, the disclosure of each of which hereby is incorporated by reference in entirety, also can be present. The additive can be present in an amount of from about 0.05 to about 5%, from about 0.1 to about 2% of the toner, which can be added during aggregation or blended into the formed toner product.

Silica, for example, can enhance toner flow, tribo control, admix control, improved development and transfer stability and higher toner blocking temperature. Zinc, calcium or magnesium stearate also can provide developer conductivity, tribo enhancement, higher toner charge and charge stability. The external surface additives can be used with or without a coating or shell.

A particle can contain at the surface one or more silicas, one or more metal oxides, such as, a titanium oxide and a cerium oxide, a lubricant, such as, a zinc stearate and so on. In some embodiments, a particle surface can comprise two silicas, two metal oxides, such as, titanium oxide and cerium oxide, and a lubricant, such as, a zinc stearate. All of those surface components can comprise about 5% by weight of a toner particle weight. There can also be blended with the toner compositions, external additive particles including flow aid additives, which additives may be present on the surface of the toner particles. Examples of these additives include metal oxides like titanium oxide, tin oxide, mixtures thereof, and the like; colloidal silicas, such as AEROSIL®, metal salts and metal salts of fatty acids, including zinc stearate, aluminum oxides, cerium oxides, and mixtures thereof. Each of the external additives may be present in embodiments in amounts of from about 0.1 to about 5 wt %, from about 0.1 to about 1 wt %, of the toner. Several of the aforementioned additives are illustrated in U.S. Pat. Nos. 3,590,000, 3,800,588, and 6,214,507, the disclosure of each of which is incorporated herein by reference.

Toners of the instant disclosure also may possess a parent toner charge per mass ratio (q/m) of from about −5 μC/g to about −90 μC/g, and a final toner charge after surface additive blending of from about −15 μC/g to about −80 μC/g.

Other desirable characteristics of a toner include storage stability, particle size integrity, high rate of fusing to the substrate or receiving member, sufficient release of the image from the photoreceptor, nondocument offset, use of smaller-sized particles and so on, and such characteristics can be obtained by including suitable reagents, suitable additives or both, and/or preparing the toner with particular protocols.

The dry toner particles, exclusive of external surface additives, may have the following characteristics: (1) volume average diameter (also referred to as “volume average particle diameter”) of from about 2.5 to about 20 μm, from about 2.75 to about 10 μm, from about 3 to about 7.5 μm; (2) number average geometric standard deviation (GSDₙ) and/or volume average geometric standard deviation (GSDᵥ) of from about 1.15 to about 1.35, from about 1.15 to about 1.25; and (3) circularity of from about 0.90 to about 0.985 (measured with, for example, a Sysmex FPIA 2100 analyzer), from about 0.91 to about 0.98, from about 0.92 to about 0.97.

### II. Developers

A. Composition

The toner particles thus formed may be formulated into a developer composition. For example, the toner particles may be mixed with carrier particles to achieve a two component developer composition. The toner concentration in the developer may be from about 1% to about 25% by weight of the total weight of the developer, in embodiments, from about 2% to about 15% by weight of the total weight of the developer, with the remainder of the developer composition being the carrier. However, different toner and carrier percentages may be used to achieve a developer composition with desired characteristics.

1. Carrier

Examples of carrier particles for mixing with the toner particles include those particles that are capable of triboelectrically obtaining a charge of polarity opposite to that of the toner particles. Illustrative examples of suitable carrier particles include granular zircon, granular silicon, glass, steel, nickel, ferrites, iron ferrites, silicon dioxide, one or more polymers and the like. Other carriers include those disclosed in U.S. Pat. Nos. 3,847,604; 4,937,166; and 4,935,326.

In embodiments, the carrier particles may include a core with a coating thereover, which may be formed from a polymer or a mixture of polymers that are not in close proximity thereto in the triboelectric series, such as, those as taught herein or as known in the art. The coating may include fluoropolymers, such as, polyvinylidene fluorides, polymers or copolymers of acrylates and methacryrates, terpolymers of styrene, methyl methacrylates, silanes, such as triethoxy silanes, tetrafluoroethylenes, other known coatings and the like.

The carrier particles may be prepared by mixing the carrier core with polymer in an amount from about 0.05 to about 10% by weight, from about 0.01 to about 3% by weight, based on the weight of the coated carrier particle, until adherence thereof to the carrier core is obtained, for example, by mechanical impaction and/or electrostatic attraction.

In embodiments, suitable carriers may include a steel core, for example, of from about 25 to about 100 μm in size, from about 50 to about 75 μm in size, coated with about 0.5% to about 10% by weight, from about 0.7% to about 5% by weight of a polymer mixture including, for example, methylacrylate and carbon black, using the process described, for example, in U.S. Pat. Nos. 5,236,629 and 5,330,874.

### III. Devices Comprising a Toner Particle

Toners and developers can be combined with a number of devices ranging from enclosures or vessels, such as, a vial, a bottle, a flexible container, such as a bag or a package, and so on, to devices that serve more than a storage function.

A. Imaging Device Components

The toner compositions and developers of interest can be incorporated into devices dedicated, for example, to delivering same for a purpose, such as, forming an image. Hence, particularized toner delivery devices are known, see, for example, U.S. Pat. No. 7,822,370, and can contain a toner preparation or developer of interest. Such devices include cartridges, tanks, reservoirs and the like, and can be replaceable, disposable or reusable. Such a device can comprise a storage portion; a dispensing or delivery portion; and so on; along with various ports or openings to enable toner or developer addition to and removal from the device; an optional portion for monitoring amount of toner or developer in the device; formed or shaped portions to enable siting and seating of the device in, for example, an imaging device; and so on.

B. Toner or Developer Delivery Device

A toner or developer of interest may be included in a device dedicated to delivery thereof, for example, for recharging or refilling toner or developer in an imaging device component, such as, a cartridge, in need of toner or developer, see, for example, U.S. Pat. No. 7,817,944, wherein the imaging device component may be replaceable or reusable.

### IV. Imaging Devices

The toners or developers can be used for electrostatographic or electrophotographic processes, including those disclosed in U.S. Pat. No. 4,295,990, the disclosure of which hereby is incorporated by reference in entirety. In embodiments, any known type of image development system may be used in an image developing device, including, for example, magnetic brush development, jumping single component development, hybrid scavengeless development (HSD) and the like. Those and similar development systems are within the purview of those skilled in the art.

Color printers commonly use four housings carrying different colors to generate full color images based on black plus the standard printing colors, cyan, magenta and yellow. However, in embodiments, additional housings may be desirable, including image generating devices possessing five housings, six housings or more, thereby providing the ability to carry additional toner colors to print an extended range of colors (extended gamut).

The gloss of a toner may be influenced by the amount of retained metal ion, such as, Al³⁺, in a toner particle. Aspartic acid derivatives are employed as chelating agents for EA toner preparation to remove excess metal ion, such as, aluminum, in toner particles.

In embodiments, toner gloss can be tuned to a desired level by employing graded amounts of sequestering agent to regulate the amount of retained metal ion in the toner. Gloss can be determined as known in the art, for example, using a glossmeter (BYK-Garner, Columbia, Md.). Hence, toner that has a gloss that matches the gloss of the substrate to which the toner is applied, a matte or dull gloss or a shiny or high gloss finish can be obtained by varying the amount of bio-based chelator during toner preparation.

In the case of HIDS, for example, a linear relationship between HIDS amount and retained aluminum ion in the toner is found with the following formula depicting the relationship:

Al⁺³ in toner (ppm dry toner)=a×HIDS (mole/100 g dry toner)+b

wherein a is from about 500 to about 1500 and b is from about 200 to about 1200.

The following Examples illustrate embodiments of the instant disclosure. The Examples are intended to be illustrative only and are not intended to limit the scope of the present disclosure. Parts and percentages are by weight unless otherwise indicated. As used herein, “room temperature,” (RT) refers to a temperature of from about 20° C. to about 30° C.

### EXAMPLES

### Comparative Example 1

### No Chelating Agent

Into a 2 liter glass reactor equipped with an overhead mixer were added 83.36 g LMW amorphous resin emulsion (M_{w}=19,400, T_{g} onset=60° C., 37 wt %), 78.55 g HMW amorphous resin emulsion (M_{w}=86,000, T_{g} onset=56° C., 38.5 wt %), 27.28 g crystalline resin emulsion (M_{w}=23,300, Mₙ=10,500, Tₘ=71° C., 35.60 wt %), 44.35 g styrene acrylate gel latex (24.81 wt %), 42.53 g R3690A polymethylene wax dispersion (IGI, containing 2.5 pph TaycaPower BN2060 surfactant, 30.37 wt %) and 48.77 g cyan pigment PB15:3 (17.21 wt %). Separately, 2.51 g Al₂(SO₄)₃ (27.85 wt %) were added as flocculent under homogenization. The mixture was heated to 39° C. to aggregate the particles while stirring at 380 rpm. The particle size was monitored with a COULTER COUNTER until the core particles reached a volume average particle size of 4.63 μm with a GSDv of 1.25. Then a mixture of 54.03 g and 50.91 g of the LMW and HMW resins noted above were added as shell material, resulting in core-shell particles with an average particle size of 6.02 μm, GSDv of 1.20. Thereafter, the pH of the reaction slurry was increased to 8.5 using a 4 wt % NaOH solution to freeze or to stop toner growth. After freezing, the reaction mixture was heated to 95° C. and the pH was reduced to 6.35 using a pH5.7 acetic acid/sodium acetate (HAc/NaAc) buffer solution which was added over about 30 min at 95° C. using a feeding pump, for coalescence. The toner was quenched after coalescence resulting in a final particle size of 6.15 μm, GSDv of 1.24 and circularity of 0.969. The toner slurry was then cooled to room temperature, separated by sieving (25 μm), filtered, washed and freeze dried.

The materials and methods of this example were used in the following examples except for alterations in amounts and the like as detailed in the individual examples.

### Comparative Example 2

### 0.5 pph EDTA as Chelating Agent

Into a 2 liter glass reactor equipped with an overhead mixer were added 84.15 g LMW amorphous resin emulsion (37 wt %), 79.29 g HMW amorphous resin emulsion (38.5 wt %), 29.23 g crystalline resin emulsion (35.60 wt %), 63.36 g styrene acrylate gel latex (24.81 wt %), 45.56 g R3690A wax dispersion (30.37 wt %) and 52.25 g cyan pigment PB15:3 (17.21 wt %). Separately 2.69 g Al₂(SO₄)₃ (27.85 wt %) were added as flocculent under homogenization. The mixture was heated to 46.4° C. to aggregate the particles while stirring at 300 rpm. The particle size was monitored with a COULTER COUNTER until the core particles reached a volume average particle size of 4.63 μm with a GSDv of 1.23. A mixture of 57.89 g and 54.55 g of the LMW and HMW resin emulsions were added as shell material resulting in core-shell structured particles with an average particle size of 5.83 μm, GSDv of 1.20. Thereafter, the pH of the reaction slurry was increased to 8.5 using a 4 wt % NaOH solution followed by 1.92 g EDTA (39 wt %) to freeze toner growth. After freezing, the reaction mixture was heated to 95° C. and the pH was reduced to 5.98 using a pH5.7 HAc/NaAc buffer solution which was added over about 60 min at 95° C. using a feeding pump, for coalescence. The toner was quenched after coalescence resulting in a final particle size of 6.02 μm, GSDv of 1.25 and circularity of 0.964. The toner slurry was then cooled to room temperature, separated by sieving (25 μm), filtered, washed and freeze dried.

### Comparative Example 3

### 0.8 pph EDTA as Chelating Agent

Into a 2 liter glass reactor equipped with an overhead mixer were added 84.29 g LMW amorphous resin emulsion (35.58 wt %), 86.43 g HMW amorphous resin emulsion (34.7 wt %), 22.33 g crystalline resin emulsion (35.60 wt %), 10.14 g styrene acrylate gel latex (24.81 wt %), 36.45 g R3690A wax dispersion (30.37 wt %) and 41.80 g cyan pigment PB15:3 (17.21 wt %). Separately, 2.15 g Al₂(SO₄)₃ (27.85 wt %) were added as flocculent under homogenization. The mixture was heated to 42.5° C. to aggregate the particles while stirring at 300 rpm. The particle size was monitored with a COULTER COUNTER until the core particles reached a volume average particle size of 5.31 μm with a GSDv of 1.21. Then, a mixture of 48.16 g and 49.38 g of the above mentioned LMW and HMW resin emulsions were added as shell material resulting in core-shell structured particles with an average particle size of 6.08 μm, GSDv of 1.20. Thereafter, the pH of the reaction slurry was then increased to 8.5 using a 4 wt % NaOH solution followed by 2.46 g EDTA (39 wt %) to freeze the toner growth. After freezing, the reaction mixture was heated to 85° C., and pH was reduced to 6.5 using a pH5.7 HAc/NaAc buffer solution, which was added stepwise over about 5 hr at 85° C., for coalescence. The toner was quenched after coalescence resulting in a final particle size of 6.34 μm, GSDv of 1.20 and circularity of 0.975. The toner slurry was then cooled to room temperature, separated by sieving (25 μm), filtered, washed and freeze dried.

### Comparative Example 4

### 1.0 pph EDTA as Chelating Agent

Into a 2 liter glass reactor equipped with an overhead mixer were added 94.49 g LMW amorphous resin emulsion (37 wt %), 89.03 g HMW amorphous resin emulsion (38.5 wt %), 29.23 g crystalline resin emulsion (35.60 wt %), 31.68 g styrene acrylate gel latex (24.81 wt %), 45.56 g R3690A wax dispersion (30.37 wt %) and 52.25 g cyan pigment PB15:3 (17.21 wt %). Separately, 2.69 g Al₂(SO₄)₃ (27.85 wt %) were added as flocculent under homogenization. The mixture was heated to 47.4° C. to aggregate the particles while stirring at 345 rpm. The particle size was monitored with a COULTER COUNTER until the core particles reached a volume average particle size of 4.83 μm with a GSDv of 1.21. Then, a mixture of 57.89 g and 54.55 g of the above LMW and HWM resin emulsions were added as shell material, resulting in core-shell structured particles with an average particle size of 5.83 μm, GSDv of 1.20. Thereafter, the pH of the reaction slurry was increased to 8.5 using a 4 wt % NaOH solution followed by 3.85 g EDTA (39 wt %) to freeze toner growth. After freezing, the reaction mixture was heated to 85° C. and the pH was reduced to 6.5 using a pH5.7 HAc/NaAc buffer solution which was added stepwise over about 2 hr at 85° C., for coalescence. The toner was quenched after coalescence and had a final particle size of 5.90 μm, GSDv of 1.22. The toner slurry was then cooled to room temperature, separated by sieving (25 μm), filtered, washed and freeze dried.

### Example 1

### 0.77 pph HIDS as Chelating Agent

Into a 2 liter glass reactor equipped with an overhead mixer were added 104.98 g LMW amorphous resin emulsion (37 wt %), 111.93 g HMW amorphous resin emulsion (34.7 wt %), 28.91 g crystalline resin emulsion (35.60 wt %), 45.56 g R3690A wax dispersion (30.37 wt %) and 52.25 g cyan pigment PB15:3 (17.21 wt %). Separately, 2.69 g Al₂(SO₄)₃ (27.85 wt %) were added as flocculent under homogenization. The mixture was heated to 48.9° C. to aggregate the particles while stirring at 365 rpm. The particle size was monitored with a COULTER COUNTER until the core particles reached a volume average particle size of 5.15 μm with a GSDv of 1.21. Then, a mixture of 57.89 g and 61.73 g of the LMW and HMW resin emulsions were added as shell material resulting in core-shell structured particles with an average particle size of 5.54 μm, GSDv of 1.18. Thereafter, the pH of the reaction slurry was increased to 8.5 using a 4 wt % NaOH solution followed by 2.343 g HIDS (Nippon Shokubai) (50 wt %) to freeze toner growth. After freezing, the reaction mixture was heated to 85° C. and pH was reduced to 6.6 using a pH5.7 HAc/NaAc buffer solution which was added stepwise over about 1 hr at 85° C., for coalescence. The toner was quenched after coalescence resulting in a final particle size of 5.83 μm, GSDv of 1.19. The toner slurry was then cooled to room temperature, separated by sieving (25 μm), filtered, washed and freeze dried.

### Example 2

### 0.98 pph HIDS as Chelating Agent

Into a 2 liter glass reactor equipped with an overhead mixer were added 83.98 g LMW amorphous resin emulsion (37 wt %), 79.13 g HMW amorphous resin emulsion (38.5 wt %), 23.13 g crystalline resin emulsion (35.60 wt %), 36.45 g R3690A wax dispersion (30.37 wt %) and 41.80 g cyan pigment PB15:3 (17.21 wt %). Separately, 2.15 g Al₂(SO₄)₃ (27.85 wt %) were added as flocculent under homogenization. The mixture was heated to 49.6° C. to aggregate the particles while stirring at 300 rpm. The particle size was monitored with a COULTER COUNTER until the core particles reached a volume average particle size of 4.68 μm with a GSDv of 1.22. Then, a mixture of 46.31 g and 49.38 g of the above LMW and HMW resin emulsions were added as shell material resulting in core-shell structured particles with an average particle size of 5.90 μm, GSDv of 1.19. Thereafter, the pH of the reaction slurry was increased to 8.5 using a 4 wt % NaOH solution followed by 2.343 g HIDS (50 wt %) to freeze toner growth. After freezing, the reaction mixture was heated to 85° C. and the pH was reduced to 6.7 using an HAc/NaAc buffer solution which was added stepwise over about 2.5 hr at 85° C., for coalescence. The toner was quenched after coalescence, resulting in a final particle size of 6.08 μm, GSDv of 1.20 and circularity of 0.976. The toner slurry was then cooled to room temperature, separated by sieving (25 μm), filtered, washed and freeze dried.

### Example 3

### 1.17 pph HIDS as Chelating Agent

Into a 2 liter glass reactor equipped with an overhead mixer were added 83.98 g LMW amorphous resin emulsion (37 wt %), 89.55 g HMW amorphous resin emulsion (34.7 wt %), 23.13 g crystalline resin emulsion (35.60 wt %), 36.45 g R3690A wax dispersion (30.37 wt %) and 41.80 g cyan pigment PB15:3 (17.21 wt %). Separately, 2.15 g Al₂(SO₄)₃ (27.85 wt %) were added as flocculent under homogenization. The mixture was heated to 47.4° C. to aggregate the particles while stirring at 300 rpm. The particle size was monitored with a COULTER COUNTER until the core particles reached a volume average particle size of 4.88 μm with a GSDv of 1.24. Then, a mixture of 46.31 g and 49.38 g of the above LMW and HMW resin emulsions were added as shell material resulting in core-shell structured particles with an average particle size of 6.02 μm, GSDv of 1.19. Thereafter, the pH of the reaction slurry was increased to 8.5 using a 4 wt % NaOH solution followed by 2.812 g HIDS (50 wt %) to freeze toner growth. After freezing, the reaction mixture was heated to 85° C. and the pH was reduced to 6.8 using a pH5.7 HAc/NaAc buffer solution which was added stepwise over about 3 hr at 85° C., for coalescence. The toner was quenched after coalescence resulting in a final particle size of 6.08 μm, GSDv of 1.22 and circularity of 0.977. The toner slurry was cooled to room temperature, separated by sieving (25 μm), filtered, washed and freeze dried.

### Example 4

### 1.46 pph HIDS as Chelating Agent

Into a 2 liter glass reactor equipped with an overhead mixer were added 83.98 g LMW amorphous resin emulsion (37 wt %), 79.13 g HMW amorphous resin emulsion (38.5 wt %), 23.13 g crystalline resin emulsion (35.60 wt %), 36.45 g R3690A wax dispersion (30.37 wt %) and 41.80 g cyan pigment PB15:3 (17.21 wt %). Separately, 2.15 g Al₂(SO₄)₃ (27.85 wt %) were added as flocculent under homogenization. The mixture was heated to 49.3° C. to aggregate the particles while stirring at 300 rpm. The particle size was monitored with a COULTER COUNTER until the core particles reached a volume average particle size of 4.49 μm with a GSDv of 1.24. Then, a mixture of 46.31 g and 43.64 g of the above LMW and HMW resin emulsion were added as shell material resulting in core-shell structured particles with an average particle size of 5.90 μm, GSDv of 1.25. Thereafter, the pH of the reaction slurry was increased to 8.5 using a 4 wt % NaOH solution followed by 3.515 g HIDS (50 wt %) to freeze toner growth. After freezing, the reaction mixture was heated to 85° C. and the pH was reduced to 6.42 using a pH5.7 HAc/NaAc buffer solution which was added stepwise over about 1 hr at 85° C., for coalescence. The toner was quenched after coalescence resulting in a final particle size of 5.96 μm, GSDv of 1.23 and circularity of 0.977. The toner slurry was then cooled to room temperature, separated by sieving (25 μm), filtered, washed and freeze dried.

### Example 5

### Effect of EDTA Loading on Residual Al in Toner Particles

Table I presents the residual amount of Al cation in toner particles of Comparative Examples 1-4, as measured by inductively coupled plasma (ICP) mass spectrometry with different loadings of EDTA in the toner preparation process. EDTA loading was measured as both pph (mass of effective EDTA weight vs dry toner mass) and moles of effective EDTA per 100 g dry toner.

TABLE I

| | EDTA loading | EDTA loading | Al ion in dry |
|---|---|---|---|
| | (pph based | (mole per 100 | toner particles |
| Toner | on dry toner) | g dry toner) | (ppm) |
| Comparative | 0 | 0 | 751 |
| Example 1 | | | |
| Comparative | 0.5 | 0.171 | 454.5 |
| Example 2 | | | |
| Comparative | 0.8 | 0.274 | 164.5 |
| Example 3 | | | |
| Comparative | 1 | 0.342 | 114.7 |
| Example 4 | | | |

### Example 6

### Effect of HIDS Loading on Residual Al in Toner Particles

Table II shows the residual amount of Al cation in toner particles as measured by ICP when HIDS was used at different loadings in toner preparation.

TABLE II

| | HIDS loading | HIDS loading | Al in dry |
|---|---|---|---|
| | (pph based | (mole per 100 | toner particles |
| Toner | on dry toner | g dry toner) | (ppm) |
| Comp. example 1 | 0 | 0 | 751 |
| Example 1 | 0.77 | 0.293893 | 488 |
| Example 2 | 0.98 | 0.374046 | 325 |
| Example 3 | 1.17 | 0.446565 | 312.4 |
| Example 4 | 1.46 | 0.557252 | 149 |

### Example 7

### Relationship Between Retained Aluminum Versus the Chelating Agent Loading for EDTA and HIDS

The results indicate that the amount of remained Al ions in toner particles has a linear relationship with EDTA or HIDS loading within the tested range for EA toner. When residual Al level in toner (ppm) was plotted versus chelating agent loading (moles per 100 g dry toner), the HIDS curve comprises a slope of about −1000 ppm per mole HIDS per 100 g dry toner while the EDTA curve had a slope of about −2000 ppm Al per mole EDTA per 100 g dry toner. Thus, HIDS also provides more latitude and control over removing graded amounts of Al ions in toner. Combination of the sequestering agent of interest with coalescence occurring following acidification of the reaction mixture enabled good particle size distribution at all the tested ranges, including at low HIDS loading when much more flocculant (Al ions) remained in the toner reaction system.

It will be appreciated that various features of the above-disclosed and other features and functions, or alternatives thereof, may be desirably combined into many other different systems or applications. Also various presently unforeseen or unanticipated alternatives, modifications, variations or improvements therein may be subsequently made by those skilled in the art, which are also intended to be encompassed by the following claims. Unless specifically recited in a claim, steps or components of claims should not be implied or imported from the specification or any other claims as to any particular order, number, position, size, shape, angle, color or material.

All references cited herein are herein incorporated by reference in entirety.

We claim:

1. A method for making a toner particle comprising:
a) contacting at least one amorphous resin, an optional crystalline resin, an optional wax and an optional colorant to form an emulsion mixture;
b) adding a flocculent comprising a metal ion to said mixture to form particles;
c) optionally adding a shell resin to said mixture;
d) adding an aspartic acid derivative to said mixture;
e) adjusting pH of the mixture from about 4 to about 8;
f) increasing temperature to about 99° C.;
g) reducing pH to from about 4.5 to about 7.5; and
h) collecting produced toner particle.

2. The method of claim 1, wherein said aspartic acid derivative comprises ethylenediamine disuccinic acid (EDDS), iminodisuccinic acid (ISA), N-bis[2-(1,2-dicarboxyethoxy)ethyl]aspartic acid (BCA6), 3-hydroxy-2,2′-iminodisuccinic acid (HIDS), hyroxy-2-2′ imino disuccinic acid or methyl glycidil diacetic acid.

3. The method of claim 1, wherein said aspartic acid derivative comprises 3-hydroxy-2,2′-iminodisuccinic acid (HIDS).

4. The method of claim 1, wherein said metal ion comprises aluminum zinc, magnesium, calcium or sodium.

5. The method of claim 1, wherein said flocculant comprises aluminum sulfate.

6. The method of claim 1, wherein residual amount of flocculant ion in said toner particle correlates directly with the amount of aspartic acid derivative.

7. The method of claim 4, wherein residual amount of aluminum ion in said toner particle correlates directly with the amount of aspartic acid derivative.

8. The method of claim 1, wherein said derivative is in an amount of at least about 0.5 parts per hundred of solid weight of dry toner.

9. The method of claim 8, wherein the amount of said HIDS in moles per 100 g dry toner and said aluminum ion in ppm toner is expressed by the equation:
Al⁺³ in toner (ppm dry toner)=a×HIDS (mole/100 g dry toner)+b
wherein a is from about 500 to about 1500 and b is from about 200 to about 1200.

10. The method of claim 1, wherein said toner particle is from about 5 to about 6 μm in diameter with a circularity of from about 0.90 to about 0.985.

11. The method of claim 1, wherein step g) comprises adding an acetic acid/sodium acetate buffer to said mixture.

12. A toner particle-forming mixture comprising at least one amorphous resin, a flocculent comprising a metal ion and an aspartic acid derivative.

13. The emulsion of claim 12, wherein said aspartic acid derivative comprises ethylenediamine disuccinic acid (EDDS), iminodisuccinic acid (ISA), N-bis[2-(1,2-dicarboxyethoxy)ethyl]aspartic acid (BCA6), 3-hydroxy-2,2′-iminodisuccinic acid (HIDS), hyroxy-2-2′ imino disuccinic acid or methyl glycidil diacetic acid.

14. The emulsion of claim 12, wherein said aspartic acid derivative comprises 3-hydroxy-2,2′-imino disuccinic acid (HIDS).

15. The emulsion of claim 12, wherein said metal ion comprises aluminum, sodium, zinc, calcium or magnesium.

16. The emulsion of claim 12, wherein said flocculant comprises aluminum sulfate.

17. The emulsion of claim 12, further comprising a crystalline resin.

18. The emulsion of claim 12, further comprising a wax.

19. The emulsion of claim 12, further comprising a colorant.

20. The emulsion of claim 12, comprising a high molecular weight amorphous resin and a low molecular weight amorphous resin.
